(19) United States
(12) Patent Application Publication
(10) Pub. No.: US 2007/0269109 A1
(43) Pub. Date: Nov. 22, 2007

(54) Method and apparatus for processing selected images on image reproduction machines

(76) Inventor: Jakob Ziv-El, Herzliya (IL)

Correspondence Address: RAYMOND A. BOGUCKI, #109, 6914 CANBY AVE., RESEDA, CA, 91335, US

(21) Appl. No.: 11/818,546

(22) Filed: Jun. 15, 2007

Related U.S. Application Data
(63) Continuation-in-part of application No. 11/384,729, filed on Mar. 20, 2006.
(60) Provisional application No. 60/664,547, filed on Mar. 23, 2005.

(51) Int. Cl. G06K 9/34

(52) U.S. Cl. 382/173

(57) ABSTRACT

A method and apparatus for processing an image using a copier, scanner or camera by designating the part of the image to be processed with at least one small uniquely designed indicia element, such as a patterned tile or lightly adherent tab, and processing the image according to the location of the indicia and/or the indicia pattern. This invention can be used for executing in fewer steps conventional tasks requiring higher computer literacy, such as cropping and assembly of graphics and/or text. It can also be used for executing unique tasks such as the reproduction of an image which is larger than the bed of the flatbed copier or scanner being used; or avoidance of a skew copy due to a skewly loaded document; or prevention of shadows near the spine or edges when copying thick books, or for translating a designated passage from a document into a desired language.

### REFERENCE TO PRIOR APPLICATION

This application relies for priority on provisional application Ser. No. 60/664,547 filed Mar. 23, 2005 and patent application Ser. No. 11/384,729 filed Mar. 20,2006.

### TECHNICAL FIELD

The present invention relates to known digital image capturing and reproduction machines including copiers, scanners, more particularly to flatbed scanners, handheld scanners, sheet fed scanners, drum scanners and cameras, and the processing of the images captured by methods and apparatus to selectively derive images and parts thereof in a facile manner.

### BACKGROUND OF THE INVENTION

There is a need for a functionally efficient method and apparatus for capturing one or more selected images, including text from one or more documents, possibly processing the images according to specific characteristics such as orientation, resolution, brightness, size, language and location, and excluding undesired images, for reasons of clarity or aesthetics, and displaying or assembling the result in a document.

Digital copiers and scanners generally rely on the movement of a linear array of electro-optical sensor elements relative to the document whose image is being captured serially. It is not possible to easily capture and reproduce a desired area of a document and exclude undesired parts when the linear array of sensors is wider than the width of the desired image or the relative travel of the sensors is greater than the length of the desired image. For example, this is usually the case when desiring to copy a picture or a paragraph from the center column of a multi-column newspaper. The difficulty of capturing only the desired image is obviously even greater when the image comprises, for example, a few sentences within a paragraph and where the desired text starts at a word within a line and ends before the end of another line.

There is also a need to easily assemble say a one page document from short extracts of several documents using a copier. Also there is a problem of capturing the image of a document which is larger than the bed of the flatbed copier or scanner being used.

In the case where there is a two dimensional array of electro-optical sensor elements, such as in a camera, the aspect ratio of the camera sometimes does not match the ratio of width to height of the particular image one wishes to capture, even if one were to use the normal zoom facility. The consequence of these inequalities is the capture of an extraneous image in addition to the image desired. A way of overcoming this problem is described in U.S. Pat. No. 6,463,220 which describes a camera with the addition of a projector for illuminating the field desired.

To avoid capturing the extraneous images in scanners and copiers, sheets of paper may be used for blocking purposes, however these are easily disturbed and clumsy to manipulate. Alternatively in the case of scanners, the image scanned is reproduced on a computer screen and specialized software, such as Adobe®Photoshop®cs2 or Microsoft® Paint, is employed to alter the image. However this involves a relatively lengthy procedure with respect to the number of steps involved, and requires a relatively high degree of computer literacy.

Also, imperfect images are produced if the relative movement of the array of electro-optical sensors relative to the document being copied, is not at right angles such as when trying to copy a piece out of a page of a large newspaper and inadvertently placing it not squarely on the bed of a scanner or copier, or the document itself is not cut squarely, or, in the case of a handheld camera, an accidental misalignment of the image occurs.

Other imperfections that can occur are the shadows or grey areas that surround an image when scanning or copying a page from a thick book due to the curvature of pages near the spine of the book and due to the visibility of the edges of flaring pages.

In the case of image capturing apparatus without screens or monitors, such as in the majority of copiers, the only recourse to an imperfectly produced image is redo the process with hopefully better results.

Apart from having the simplest and quickest means for correcting imperfections, it is desirable to have available a simple and quick way for specifying the characteristics of the image produced. Such characteristics include resolution, brightness, size, color, location of the image reproduced, and in the case of text the font, the language to which it should be translated, indentation and other characteristics. Currently the method for setting some of these characteristics is by the use of pushbuttons on the machine or by carrying out multi-step instructions as they appear on the screen of a computer connected to a scanner. The latter requires advanced computer literacy and increases the time taken for the operation.

### SUMMARY OF THE INVENTION

In accordance with the present invention relatively complex image and word processing tasks can be executed by persons having no or limited computer literacy, using a digital copier, scanner or camera. Furthermore this can be done with fewer steps, since it avoids all or some of the usual steps such as loading an image or word processing program into a computer, then displaying the document on a screen and finally locating and executing the required functions to accomplish the task required. Examples of such relatively complex tasks include cropping pictures or text from a document; assembling pictures and/or text into a new document and possibly specifying the general characteristics of the document such as resolution, brightness, size or color. In addition to these conventional tasks, some unique tasks can now be accomplished. These include preventing a skewed or tilted image output from a copier or other image reproduction machine resulting from the original document not having been inserted in the machine in the proper angle. Another example is capturing the image of a document that is larger than the bed of the flatbed copier or scanner being used. A further example is the translation into another language of a particular part of a document, be it a word or a phrase, a sentence or paragraph, extracted from the body of a document. The logic or algorithm for accomplishing these tasks can be totally incorporated in the operating system of the copier, scanner or camera or partly or wholly located in a computer connected to these reproduction machines.

The method and apparatus of the present invention employs the placement of one or more uniquely designed indicia on the face of the document containing the image to be processed, or are placed in the vicinity of the document, provided the indicia and the document are both within the area being captured for processing. Accordingly, an expression such as “placing indicia with the document” implies placing it on the document or near the document. The indicia are used to indicate which part of the document is to be processed and/or specifies the process to be used. An indicia element or indicium comprises a lightly adherent tab or a tile with a pattern as described below. Each tab or tile is identified by the pattern and the location of each indicia element relative to the document is noted. Finally the original image is processed to produce the desired image.

The patterns on the indicia comprise a relatively unique basic pattern to which an alpha-numeric message, barcode or other code may be added. If no such additions are present they will be referred to as basic indicia, tabs or tiles. If such additions are present they will be referred to as code enhanced indicia, tabs or tiles.

In some instances the positioning of basic indicia may be sufficient to indicate a process, such as the cropping of a picture or a passage from the text of a document. On the other hand, if the process is to be virtually totally automatic, code enhanced indicia are required where the parameters to be changed have a large number of possibilities, such as resolution, brightness, color, type of font, the language into which text must be translated, etc. In the case where the image reproduction machine is controlled by an externally operated computer, the control or operation of the desired task can be shared between the reproduction machine and the computer. Thus here only basic indicia are required and their detection and positioning are detected by an algorithm residing within the operating system of, for example, the copier, while the computer is used to execute a particular task out of a choice of listed tasks on a screen, such as crop circle, crop shape, translate to Spanish, hold in memory, etc.

In what follows the various types of indicia will for convenience sometimes be referred to as tabs, but it is to be understood that tabs implies indicia including lightly adherent tabs, or tiles or stamps with a relatively unique pattern, as previously explained.

A degree of error in the inclination in the placement of the indicia must be tolerated, because the placement of these is usually by hand.

### BRIEF DESCRIPTION OF THE DRAWINGS

FIGS. 1a to 1f show examples of a variety of indicia on different media. FIGS. 1a to 1e show examples of a variety of indicia patterns printed on tabs. FIG. 1f shows an example of a basic indicia element in the form of a tile.

FIGS. 2a and 2b show the placement of tabs on a document in order to crop a particular rectangular area out of the document.

FIG. 3 shows the placement of tabs on a document in order that the desired image of the document appears in a vertical orientation.

FIGS. 4a and 4b show the placement of tabs on a document in order to crop a particular circular area out of the document. FIG. 4c shows the circular area cropped.

FIG. 5 shows the placement of tabs on a document in order to crop a particular polygon out of the document.

FIGS. 6a to 6d show the placement of tabs on documents when extracts, including images from several documents, are to be reproduced in one document.

FIGS. 7a and 7b show the placement of tabs for capturing an image that is larger than the copier bed or the scanner bed used.

FIG. 8a shows the placement of tabs on a document containing text in order to crop a particular portion of text out of the document and reproduce the text such that the start of the reproduced text lines up with the left margin. FIG. 8b shows the reproduced text. FIG. 8c shows the placement of additional tabs in an alternative method for margin recognition.

FIG. 9 illustrates the placement of tabs so that an extract from a document can be translated into another language and immediately printed.

FIGS. 10a to 10e illustrate the required setup when a camera is used for capturing and processing a designated image from a document.

FIGS. 11a and 11b show the stages of an algorithm used to recognize indicia and implement one embodiment of the invention.

FIG. 12 shows an edge map of the indicia pattern shown in FIG. 1a.

FIG. 13 shows the edge map of FIG. 12 after application of a low pass filter.

FIG. 14 shows the principal components of a system to implement the invention.

### DETAILED DESCRIPTION

In a preferred embodiment of the invention, one or more uniquely designed indicia are placed on the face of the document containing the image to be processed by copier, scanner or camera. The indicia are used to indicate which part of the document is to be processed and/or specifies the process to be used.

In the case of flatbed copiers or scanners lightly adherent, i.e. removable, tabs placed on the face of the document, are preferred since most often the document to be processed is placed face down. One type of “Lightly adherent” refers for example to the type of adhesion present in the commercial 3M product Post-It™ Notes having the trademark Scotch®. These are also referred to in the trade as “Removable self-stick notes”. Lightly adherent also refers to the use of a tab or a tile that can be kept in place by electro-magnetic force when the document is placed for example between the tabs and a magnetic plate. The reason for the tabs having to be lightly adherent is to avoid their shifting when the document is turned face down or due to air movement caused, for example, by the closing of a cover. These lightly adherent tabs avoid any visible damage to the document due to adhesion. Where damage is not a consideration, a label or an ink stamp with the indicia pattern can be used.

In the case where a document is preferably placed face up, such as when using a camera to capture the image of a document placed on a horizontal table, tiles about one square centimeter in size with a unique pattern design may be used. It is assumed that tiles, unlike small pieces of paper, are not easily disturbed.

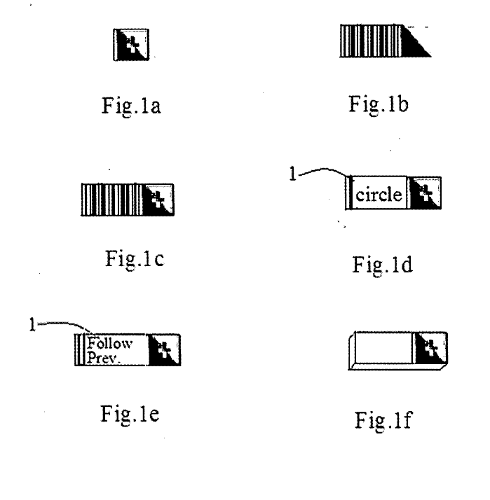

FIG. 1a represents an example of a basic indicia pattern design placed on a lightly adherent tab i.e. a basic tab.

FIG. 1b represents an example of an alternative pattern design placed on a lightly adherent tab. The advantage of the basic pattern design of FIG. 1a over that of FIG. 1b is speed of recognition due to the use of the principle of inverse indicia as will be explained.

FIGS. 1c, 1d and 1e are examples of code enhanced indicia comprising lightly adherent tabs having the basic pattern design of FIG. 1a with additional information in the form of a barcode. and in the case of FIGS. 1d and 1e, alphanumeric text. The barcode may be used to indicate that optical character recognition (OCR) and word processing should be activated.

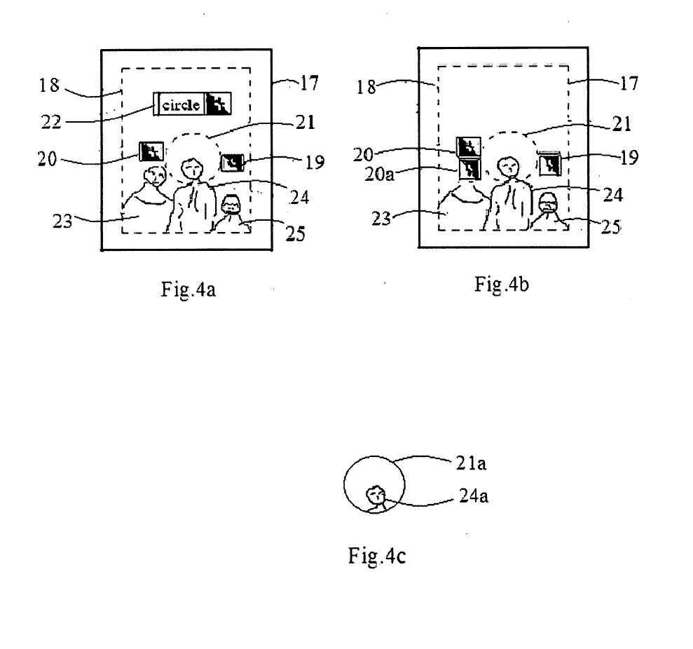

The text in FIGS. 1d and 1e serves to identify the tab type visually. If OCR is available it can also serve as an instruction to the machine on the desired output, as is the barcode. For example, FIG. 1d shows the word “circle” and is used to instruct the machine that the area to be cropped is a circle, as will be explained with reference to FIG. 4a.

FIG. 1e shows the words “Follow Prev.” and is used to instruct the machine that the current and following visual image being copied or scanned are to be assembled such that they appear together on the same document, one immediately following the other. There are two benefits to be gained from this procedure. Firstly less paper is used in the production of the document, if the images being copied comprise small sections of text and therefore need not consume a separate page for each section of text. Secondly, if the image to be copied or scanned is a document which is larger than can be accommodated on a flatbed copier or scanner, it enables individual sections of the document to be copied into memory and successively assembled for reproduction as a diminutive copy on a copier, or printed full size if the scanner is connected to a printer which can handle large documents.

FIG. 1f represents an example of the basic pattern design of FIG. 1a, placed on a tile. The presence of the rectangle to the left of the pattern, whether on a tab or tile, enables the conversion of basic indicia to code enhanced indicia by additional information that can be placed in the rectangle in the form of a bar code and/or alphanumeric characters, either preprinted or entered by hand. This presumes the presence of OCR or handwriting recognition, for reading it

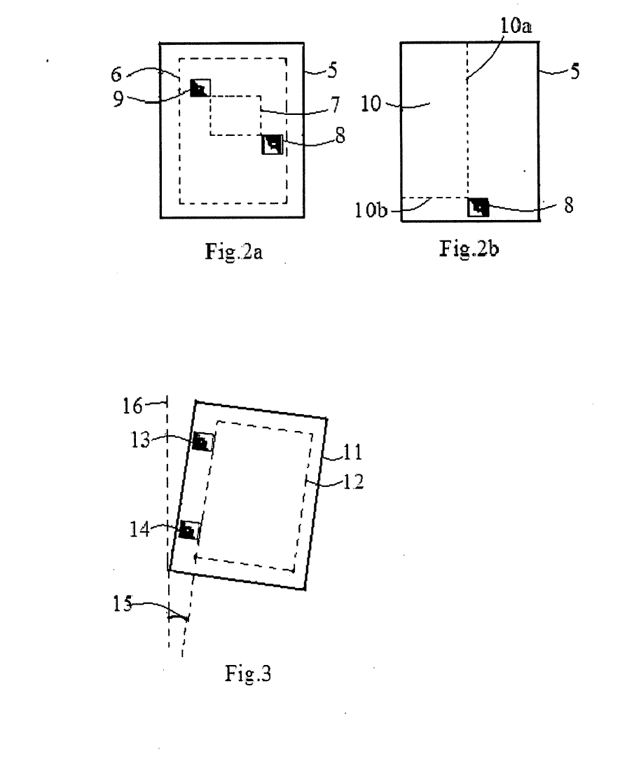

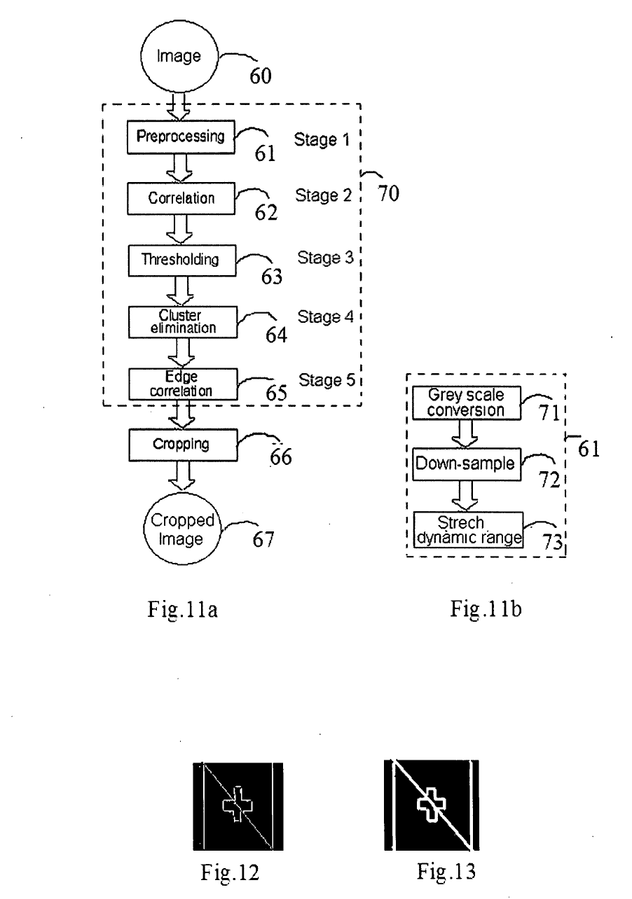

FIG. 2a shows the placement of lightly adherent tabs 9 and 8 on a document 5 with margins 6, in order to crop a particular rectangular area 7 out of the document 5. Tab 8 is rotated 180 degrees with respect to tab 9 and these two tabs define the diagonal of the rectangle 7. An algorithm used to recognize the patterns on the two tabs 9 and 8 and thereby implement the required action is explained with reference to FIGS. 11 to 14. Note that should the tab pattern 9 be moved horizontally to the left, rectangle 7 will increase in size. Thus the limiting horizontal shift of tab 9 is at the outside of the left edge of document 5, in which case instead of the adhesion being from the back of tab 9, a blank area with lightly adhesive material can be added to the right of tab 9 so that the tab adheres to the back of document 5. This is easily produced by taking a lightly adherent tab resembling FIG. 1f and folding the blank portion back under the pattern shown. The placing of such a tab outside the document is required where the image to be processed on the document extends up to the edge so that there is no room for the placement of a tab on the document itself. The document with any overhanging tabs must now be placed within the copying or scanning area of the machine being used.

FIG. 2b shows the placement of a lightly adherent tab 8 on a document 5 in the same 180 degree orientation that tab 8 appears in FIG. 2a. Here too it defines the bottom right hand corner of a rectangle. Thus in the absence of any other tab, the two sides of the rectangle 10 to be cropped are the vertical and horizontal lines 10a and 10b which meet at tab 8, while the other two sides of rectangle 10 coincide with the edge of the document 5 as shown.

FIG. 3 shows a document 11 placed at an angle 15 relative to the direction 16 of the sweep of the scanning head of a copier or scanner, or the vertical position 16 of a camera. It is normally reproduced at an angle 15 from the vertical line 16. However by placing tabs 13 and 14 on the document 11 next to the left hand side of margin 12 as shown, the image of the document will be reproduced in the desired vertical orientation instead of at the angle 15. To implement it, use is made of the algorithm for tab pattern recognition explained with reference to FIGS. 11 to 14. The angular variation 15 in FIG. 3 that is permitted is explained with reference to FIGS. 12 and 13.

FIG. 4a shows the placement of basic tabs 19, 20 and code enhanced 22 on a document 17, which shows three persons 23, 24 and 25, for cropping a particular circular area 21 out of the document 17, which has margins 18. Tab 19 is rotated 180 degrees with respect to tab 20 and both define the diameter of the circle. Code enhanced tab 22, as explained with reference to FIG. 1d, confirms that it is a circle. The recognition of the basic pattern design on tabs 20, 19, and 22, is done through the use of the algorithm explained with reference to FIGS. 11 to 14. A code enhanced tab such as tab 22 can be placed almost anywhere on the document 17 or beside the document provided it is within the copying area of the copier or the scanning area of a scanner being used. If for example it is placed in a fixed position relative to the bed of the flatbed copier or scanner, the instruction, which on tab 22 is “circle”, is located sooner. An alternative use of the code enhanced tab 22 is to replace, say, basic tab 20, in which case only two basic pattern designs need be detected by the algorithm, which speeds up operation. The programming instructions for producing a cropped circle, is well known to those skilled in the art of image processing. See for example the commercial program Adobe®Photoshop®cs2. FIG. 4c shows the cropped circular area indicated in FIG. 4a.

FIG. 4b illustrates an alternative method to that of FIG. 4a for cropping a particular circular area out of an image on a document. Instead of using a code enhanced tab 22 which requires OCR and/or a barcode reader, a second basic tab 20a rotated 180 degrees is placed directly below and adjacent to tab 20. Thus the positioning of tabs 20 and 19 designates a diameter which together with tab 20a implies a circular crop.

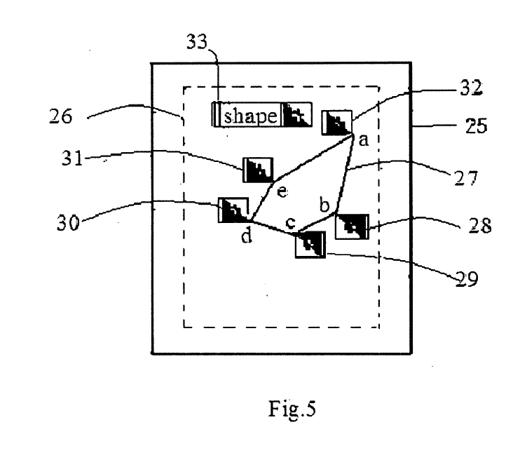

FIG. 5 shows the placement of tabs on a document 25 with margins 26 in order to crop a particular shaped polygon abcde, out of the document. Tabs 28,29,30,31 and 32 define the shape to be cropped. Tab 33, analogous to tab 22 in FIG. 4a, confirms that it is a polygon by the barcode on the left hand side of tab 33 and/or if OCR is present by virtue of the word “shape”. The placement of tab 33, like tab 22 in FIG. 4a, is in principle also not confined to a fixed position. The recognition of the basic pattern design on the tabs is done through the use of the algorithm explained with reference to FIGS. 11 to 14. The programming instructions for connecting the straight lines of the particular shaped polygon abcde and for the cropping of a polygon, is well known to those skilled in the art of image processing. See for example commercial programs Adobe®Photoshop®cs2 and Microsoft® Paint.

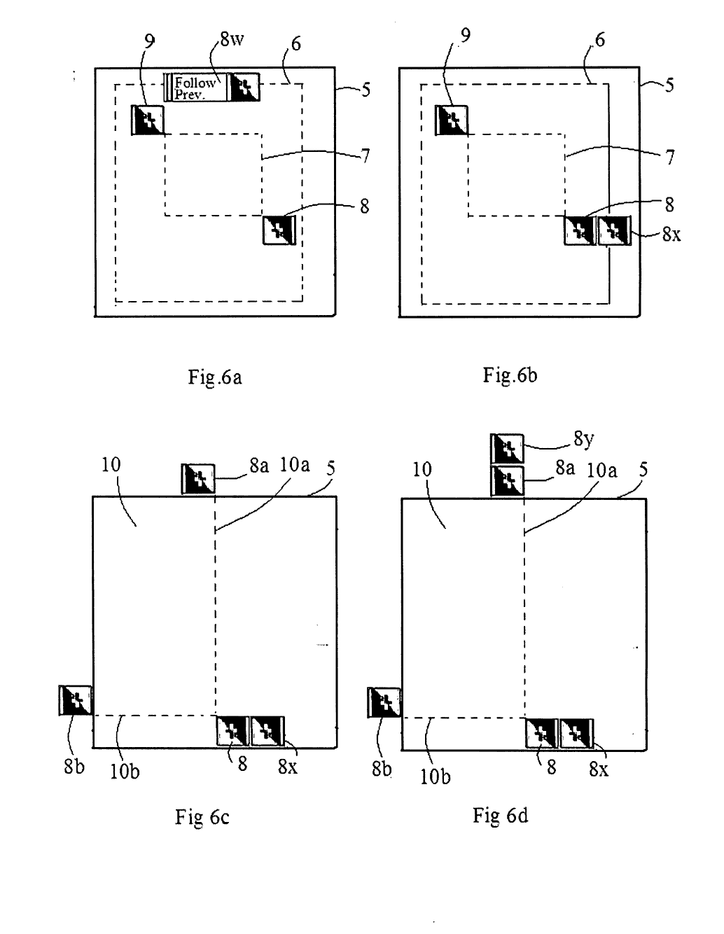

FIG. 6a shows a document 5 with margins 6. Basic tabs 9 and 8 designate rectangle 7 to be cropped. Code enhanced tab 8w, shown in FIG. 1d, has the words “Follow Prev.” written on it for instructing the machine that rectangle 7 together with an extract from the next document to be captured, should be reproduced adjacently in one continuous document. In the case of a copier, which has the algorithm (to be described with reference to FIGS. 11 to 14), incorporated into the operating system, it can be printed as a single document, possibly on one page, while in the case of a scanner or camera it will be kept in memory as a single document for possible further processing. The process can be repeated a number of times with successive documents. The placement of tab 8w, like tab 22 in FIG. 4a,is in principle also not confined to a fixed position, with each position having its own advantage.

FIG. 6b shows an alternative method for achieving the same and uses a second basic tab, 8x, placed horizontally adjacent to tab 8. Thus the positioning of basic tabs 9, 8 and 8x form a unique pattern in the layout which is recognized by the system, thereby obviating the use of tab 8w shown in FIG. 6a.

In the case where the rectangle 7 in FIG. 6b should extend to the left side up to the edge of the document 5, the left tab 9 is not needed. Thus in FIG. 6c, the vertical line 10a and the horizontal lines, 10b, designate the rectangle 10 to be cropped. Here too, the presence of horizontally adjacent tabs 8 and 8x indicates that the image of rectangle 10 must be kept in memory and that the image to be cropped from the next document will follow below line 10b.

If the edges of document 5 in FIG. 6c are not at right angles or are uneven, thereby making it difficult to ensure the locations of lines 10a and 10b, one or two additional tabs can be added. Thus placing tab 8a where desired defines the location of line 10a. Line 10b is then also defined, since 10a and 10b are automatically made at right angles when the image is processed after capturing. Alternatively, area 10 can be defined by placing two tabs 8a and 8b, however then lines 10a and 10b are not necessarily at right angles to each other.

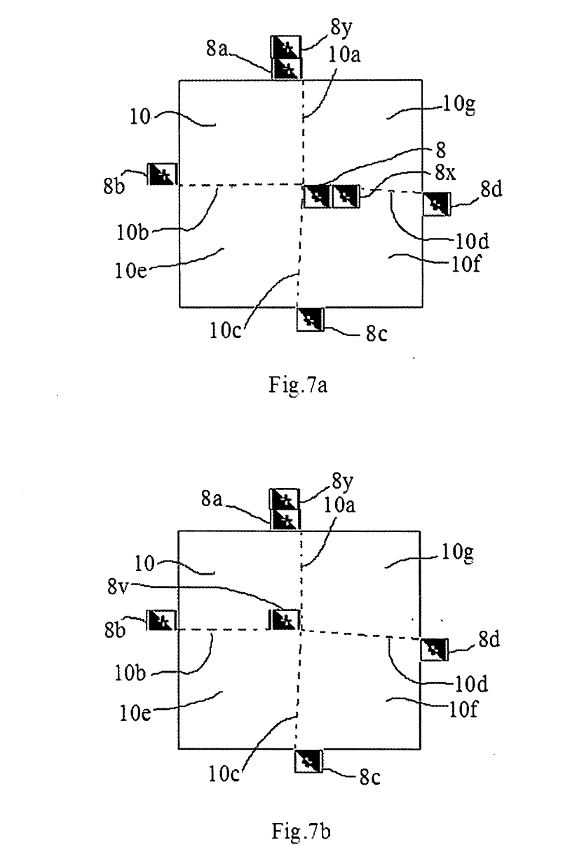

FIG. 6d shows another tab 8y added vertically above tab 8a. This specifies that at some future stage an image will be added to the right of the vertical line 10a. The adding of images is utilized in FIGS. 7a and 7b as follows.

FIG. 7a represents a document which is larger than the bed of the flatbed copier or flatbed scanner used, i.e. the outside dimensions the document exceed the dimensions of the area swept by the scanning head, implying that the width of the document exceeds the width of the scanning head and/or the length of the document exceeds the length of sweep of the scanning head, and nevertheless it is desired to reproduce the image of the document.

As a first step the image is divided into several quadrangles using tabs. In FIG. 7a, tab 8 is placed roughly in the middle and four tabs 8a, 8b, 8c and 8d are placed on the sides. Lines 10a, 10b, 10c and 10d are imaginary lines connecting these tabs thereby dividing the image into the four quadrangles 10, 10e, 10g and 10f. The angles around the central tab 8 are not necessarily right angles.

Additional tabs 8x and 8y are added so that the positioning pattern of the tabs around quadrangle 10, resembles those of FIG. 6d.

One now places the document on the copier or scanner bed so that quadrangle 10 is captured together with tabs 8y, 8a, 8, 8x and 8b. Next one captures quadrangle 10e including abs 8b, 8c 8 and 8x. Quadrangles 10 and 10e will now be joined in memory since tabs 8b and 8 are common to both quadrangles captured thus far. Thus the additional purpose of tab 8b is that the two quadrangles meet exactly on line 10b, unlike the case where two areas captured simply follow each other on the same document, possibly with a gap in between.

Next one captures quadrangle 10g together with tabs 8y, 8a, 8, 8x and 8d and by virtue of the two vertically placed tabs 8y and 8a, quadrangles 10 and 10g will now be joined in memory along the line 10a since tabs 8y, 8a, 8 and 8x are common to both quadrangles captured.

Next, as shown in FIG. 7b, one places tab 8v such that the corner of tab 8v meets the corner of tab 8 and then tabs 8 and 8x are removed as shown in FIG. 7b. Next one captures quadrangle 10f including tabs 8d, 8c and 8v. Since tabs 8d and 8c are common to overlapping quadrangles previously captured, quadrangle 10f will join along lines 10d and 10c. The main purpose of tab 8v is that it helps in orientation and also indicates roughly where the inside corner of quadrangle 10f ends when placing the document on the bed for capturing quadrangle 10f.

Having assembled the whole document in memory, its scale can be altered in memory, if necessary, to match the available output means. Thus in the case of a scanner connected to a large format printer it can be printed full size or larger. However in the case of a copier, a diminutive image is produced in memory to match the printing head width of the copier. The technology of changing of the scale of an image in memory is well known in commercial products for image manipulation currently on the market, such as Microsoft Paint.

In FIGS. 7a and 7b it is assumed that the document is somewhat smaller than twice the size of the copier or scanner bed. The principle of positioning tabs can however be extended to capture larger documents by partitioning the documents into more quadrangles and indicating with horizontally adjoining tabs, such as 8 and 8x, and vertically adjoining tabs, such as 8y and 8a, whether a captured quadrangle is to be added vertically or horizontally respectively.

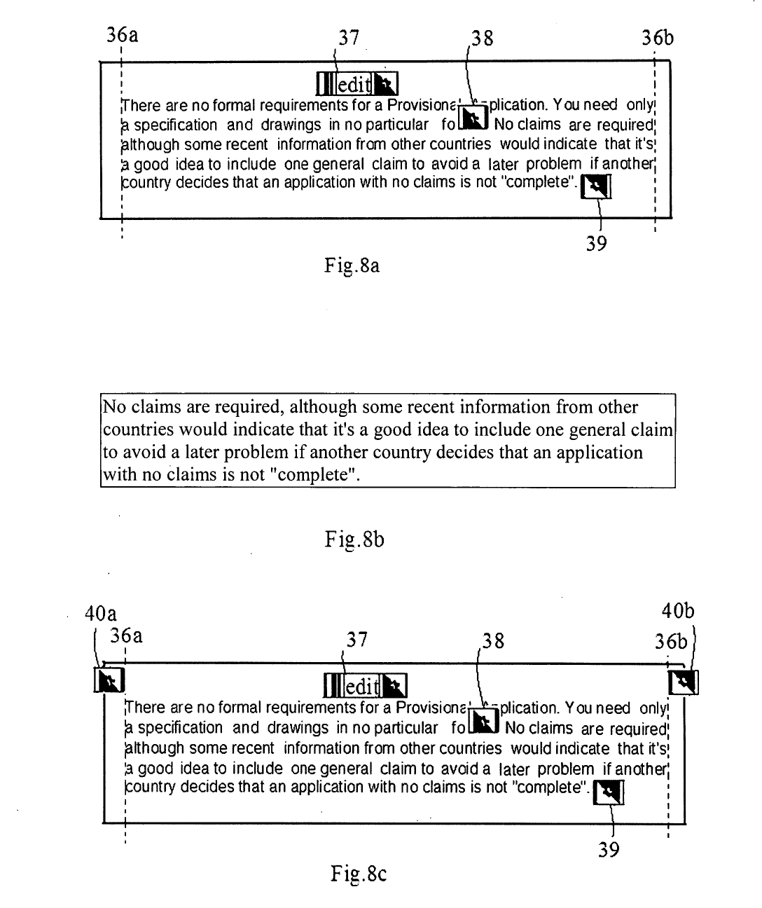

FIG. 8a shows the placement of tabs 38 and 39 on a document containing text in order to crop a particular section of the text out of the document. The code enhanced tab 37 states, analogous to specification on the tabs in FIGS. 1d and 1e, that OCR must be activated and furthermore that the text must be reedited such that the start of the reproduced text must line up with the left margin. This is indicated both by the barcode on the left hand side of tab 37 and by the printed word “edit”. The placement of tab 37, like tab 22 in FIG. 4a, is in principle also not confined to a fixed position, with each position having its own advantage. The recognition of the basic pattern design on tabs 37, 38 and 39, is done through the use of the algorithm explained with reference to FIGS. 11 to 14. The reediting of text as specified is well known to those skilled in the art of word processing.

Although the margins 36a and 36b can be recognized relatively easily by virtue of the clear margin areas on both sides of the text, the alternative is to place an additional two tabs, 40a and 40b, to designate the margins 36a and 36b respectively as shown in FIG. 8c.

FIG. 8b shows the reproduced text referred to in FIGS. 8a and 8c.

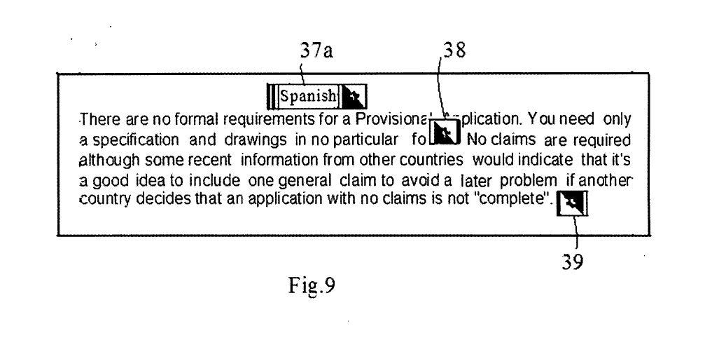

FIG. 9 shows a document where it is desired to have the text, designated as being located between basic tabs 38 and 39, translated into another language, viz. Spanish. Code enhanced tab 37a has the word Spanish written on it. The placement of tab 37a, like tab 22 in FIG. 4a, is in principle also not confined to a fixed position, with each position having its own advantage. Using OCR, the designated text is here translated into Spanish through the presence of a stored dictionary with word processing rules. In the case of a copier the Spanish translation is immediately printed. If the whole text is to be translated only tab 37a is required.

The principle of combining a scanner with a language translator is used in a product such the QuickLink Pen by WizCom Technologies Ltd., where one is required to stroke text with a handheld pen-like instrument and then the translation appears in an LCD window. The disadvantage of the QuickLink Pen is in its use for long text passages such as several sentences or paragraphs, since a steady hand is required for accurate scanning. One is required to move the hand holding the Pen steadily in straight lines without rotating the Pen. Furthermore, the production of a printed translation requires connection to a computer with printer. The physical dexterity and know-how required in the present invention is considerably less because it only entails the placing of tabs on the document and then placing the document in say, a copier where the algorithm and logic resides within the operating system.

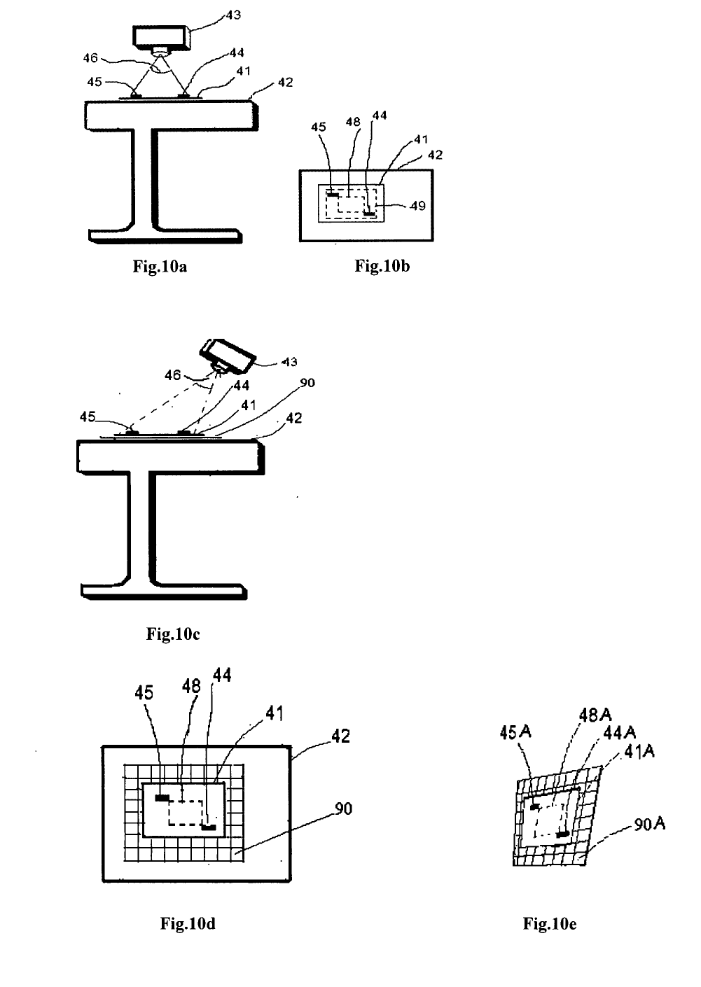

FIG. 10a shows a side view of a document 41 placed on a horizontal table 42 being photographed by a camera 43. FIG. 10b shows the top view. Indicia in the form of tabs or tiles 45 and 44 in FIG. 10b, are placed on top of the document 41 to indicate the area 48 on the document 41 that must be processed. The area is not necessarily rectangular, and represents here a general designated area including one such as in FIG. 9. The optical axis of the camera is substantially centrally and perpendicularly located with respect to the document and the tabs 45 and 44.

Generally in copiers and scanners, the distance of the electro-optical sensors relative to the part of the image of the document being read, is constant. Using a camera however, the distance of the camera to the document varies. Accordingly the image processor within the camera must take into account the apparent change in size of the indicia pattern. One way is by a change in scale according to the distance from the camera and the zooming factor if a zoom facility is used. Automatic infrared distance measurement apparatus is known and its output is fed into the image processor in the camera.

In order to increase the probability of recognition of the indicia pattern, any distortion of the image by the lens of the camera must also be taken into account by the image processor by the use of the calibration table of the lens. See Hartley and Zisserman (2003) Multiple View Geometry in Computer Vision (Cambridge University Press) pp. 178-193. This adjustment to the image captured may produce a non-uniform resolution in the resulting image. Providing the lowest resolution within the image is above 100 dpi, the next step is to change the resolution of the image to a uniform resolution of about 100 dpi, as will be explained with reference to the Down-sample block 72 in FIG. 11b which concerns the use of the algorithm explained with reference to FIGS. 11 to 14 for detecting the indicia.

FIGS. 10c to 10e are applicable to the case where the optical axis of the camera 43 is tilted, i.e. it is not substantially centrally and perpendicularly located with respect to the image being processed as in FIG. 10a.

FIG. 10c shows a side view and FIG. 10d shows the top view of a table 42, on which document 41 is shown placed on top of a grid pattern 90 drawn on a separate blank sheet. Indicia in the form of tiles or tabs 45 and 44, are placed on top of document 41 to indicate the area 48 on document 41, that must be processed. The camera 43 is offset from the central perpendicular position of the document and tilted.

The grid pattern 90 comprises black lines on a white background forming identical uniform squares of known size relative to the dimensions of the indicia pattern.

FIG. 10e shows the image of the document when the field of view of the camera is not aligned with a particular direction of the grid. (The pattern of this image can be derived through the use of projective geometry.) The squares of the grid now appear as quadrangles. The more distant the quadrangles are from the camera, the more apparent shrinking occurs in the dimensions of the squares.

The first processing step is to scan the image starting from the outside in order to detect the outside quadrangles of the grid 90A in FIG. 10e.

The image of FIG. 10e is next processed by progressively “stretching” the image, with most stretching occurring on the left of FIG. 10e, where the dimensions of each quadrangle is the smallest, so that the quadrangles of grid 90A approach squares. Such progressive “stretching” or projective transformation, means incremental non-uniform magnification of the image up to the point where the side of each quadrangle equals the size of the largest side of the quadrangles on the right of FIG. 10e. Furthermore the resulting equilateral quadrangles must increasingly approach squares i.e. the angles in the four corners become right angles.

The non-uniform magnification is accompanied by a non-uniform resolution across the image, with the lowest resolution being on the bottom left of FIG. 10e where most stretching occurs. The resolution of the whole image is next adjusted so that the resolution is made uniform and corresponds to the lowest resolution mentioned. Since for good indicia pattern recognition the final resolution should ideally not fall below 100 dpi for the indicia pattern shown, (as will be explained with reference to the Down Sample block 72 in FIG. 11b concerning the use of the algorithm for detecting the indicia), this lowest resolution limits the angle of tilt of the optical axis of the camera 43 in FIG. 10c.

Since the size of the indicia pattern relative to the size of the squares in the grid is known, the following algorithm can now be applied.

FIG. 11a shows five stages, 61 to 65 within block 70, of the algorithm used to recognize and locate the uniquely designed basic indicia pattern, such as FIG. 1a, on a tab or tile, appearing with an original visual image 60, whether captured into electronic memory by copier, scanner or camera, so that by memory scanning or serially inspecting the electronic memory the image can be processed according to the positioning of the indicia and/or according to any coded or text instructions appearing with the code enhanced indicia. When using the indicia shown in FIG. 1, some angular inclination of the indicia must be tolerated since these are invariably placed by hand and also speed of execution is important. Processing can often start while the image is being captured.

After locating the uniquely designed basic indicia pattern, any further encoding such as the barcodes or text in FIGS. 1c to 1e can be located, since these are located in the same position relative to the basic indicia pattern, and the related instructions can be executed.

FIG. 11a also shows an additional stage 66 for the particular case where it is used to produce a cropped image 67. This corresponds to rectangle 7, as described with reference to FIG. 2a, where a set of two indicia 9 and 8 are used, or circle 21 in FIG. 4, where three indicia are used.

It is obvious that the more details in the design of the basic indicia in terms of color and shape, the more unique is its design, however the more processing is needed and the longer it takes to identify an indicia element in a given surroundings. A practical compromise between uniqueness and processing time is by the use of an indicia pattern in black and white such as in FIG. 1a. Furthermore, where two indicia patterns are required, a faster and a more efficient implementation is provided when using inverse indicia patterns as will be described. Thus in the depicted configuration in FIG. 2a, the two basic indicia form a pair of inverse images, i.e. each image which when rotated through 180 degrees results in the inverse of the image, i.e. black areas are shown white and white areas are shown black.

If an indicia pattern in black and white is used then the image on which it is placed can also be simplified by eliminating some color details. This process will be referred to as part of “normalization” in Preprocessing block 61 in Stage 1 of FIG. 11a. In this regard it is noted that in day to day practice color is described in RGB (Red, Green, Blue) or HSV (Hue, Saturation, Value) representations and simplification can be achieved through the elimination of the hue and saturation components.

The five stages of the algorithm of FIG. 11a plus the additional stage are Preprocessing 61, Correlation 62, Thresholding 63, Cluster elimination 64, Edge correlation 65 and Cropping 66. The algorithm is designed to simultaneously detect both an indicia pattern and its inverse, and these can also be referred to as the “positive” and the “negative” indicia elements. If non-inverse indicia are used, two executions of the algorithm have to be applied, detecting in each execution only a single “positive” indicia element, thereby slowing the process.

It is assumed here that the intensity values of a single-channel image are within the range of [0,1], where 0 represents black and 1 represents white. Other intensity ranges (typically [0,255]) are equally applicable, as these can be normalized to the range of [0,1] through division by the high value of white.

Stage 1—Preprocessing, 61. The acquired input image is preprocessed to a “normalized” form, eliminating unneeded features and enhancing the significant details. This comprises three stages as shown in FIG. 11b. First, color information (if present) is discarded, transforming the image to single-channel grayscale mode, 71 in FIG. 11b. For a 3-channel RGB image, this can be done by eliminating the hue and saturation components in its HSV representation. For information on HSV and grayscale conversion see Gonzalez, R. C, Woods, R. E and Eddins, S. E (2004) Digital Image Processing (Pearson Prentice Hall, NJ) pp. 205-206 The image is then down-sampled to say 100 dpi resolution, 72 in FIG. 11b. The reduced resolution implies less detail and leads to shorter running times of the algorithm, however the amount of down-sampling possible is dictated by the size of the fine details in the indicia's pattern in FIG. 1a. Further down-sampling is possible if less fine detail is to be detected in the indicia, however this tends to detract from the uniqueness of the pattern. Finally, the contrast of the input image is enhanced by stretching its dynamic range within the [0,1] range, 73 in FIG. 11b, which may cause a small percentile of intensity values to saturate on the extremes of this range. For contrast stretching see Pratt, W. K (2001) Digital Image Processing, 3rd ed. (John Wiley & Sons, NY) p. 245. This step is intended to increase the significance of the correlation values in the next stage, Stage 2, in FIG. 11a.

Stage 2—Correlation(or shape matching), 62 in FIG. 11a. The uniquely designed indicia element shown in FIG. 1a, utilizes two colors, black and white. This indicia element can therefore be described as a binary (or black and white) image. In its 100 dpi-resolution representation (or more generally, the same resolution as the normalized image obtained in Stage 1), it will be referred to as the indicia kernel. For correlation see Kwakernaak, H. and Sivan, R. (1991) Modern Signals and Systems (Prentice Hall Int.), p. 62.

In this Stage 2, a correlation operation is carried out between the indicia kernel and the normalized image of Stage 1. Before the actual correlation, the intensity values of both the normalized input image and the indicia kernel are linearly transformed from the [0,1] range to the [−1,1] range, by applying the transform Y(X)=2X−1 to the intensity values. Following this transform, the two are correlated. Assuming the indicia kernel contains K pixels, then the correlation values at every location will vary from −K to +K, +K representing perfect correlation, −K representing perfect inverse correlation (i.e. perfect correlation with the inverse pattern), and 0 representing absolutely no correlation. Therefore, if one indicia element is defined as the negative of its pair, then both can be detected virtually simultaneously by examining both the highest and the lowest correlation values. This leads to significant performance gains, as the correlation stage is the most time consuming component of the algorithm. Next, the correlation values which initially span a range of [−K,+K], are linearly scaled to the normalized range of [0 . . . 1] for the next stage, using the transform Z(X)=(X+K)/2K.

Stage 3—Thresholding, 63 in FIG. 11a. In this stage the correlation values calculated in Stage 2 are thresholded, forming two sets of candidate positions for the locations of the two indicia. The set of highest correlation values, such as those between 0.7 to 1.0, are designated as candidates for the location of the positive indicia element, and similarly the set of lowest correlation values, such as those between 0.0 and 0.3, are designated as candidates for the location of the negative indicia element (if a negative indicia element is indeed to be detected).

The need to establish a set of candidate positions for each indicia element, as opposed to simply designating the highest and lowest correlation values as their true locations, arises because in practice the extreme correlation values may not necessarily indicate the actual positions of the two indicia. Several intervening factors such as noise, slight inclination of the indicia element, slight variation in size or use of reduced-contrast tabs etc. can all negatively effect the correlation values at the true indicia locations, promoting other (false) locations to occupy the extreme points. The next stages are therefore intended to detect and eliminate these “false alarms” of high correlation values, leaving only the true locations of the indicia in place.

Stage 4—Cluster elimination, 64 in FIG. 11a. An effect seen in practice is that around every image position which correlates well with the indicia kernel, several close-by positions will correlate well too, thereby producing “clusters” of high correlation values. (By “close-by” is meant distances which are small relative to the size of an indicia element). It can be assumed for the degree of accuracy required that highly-correlated positions which are very close to each other relative to the size of an indicia element all correspond to the occurrence of the same indicia element. Therefore one can select a single representative value from each such cluster—the best one—and discard the rest of the cluster.

To do this, first the candidates for selection are ordered by their correlation values, such that the candidates with values in the range 0.0 to 0.3 are in ascendant order and those in the 0.7 to 1.0 range are in descendant order. Next, one iterates through the ordered candidates, and checks for each one if there exist other, less-well correlated candidates for the same indicia kernel, in a circular area of fixed radius about it, as stated below. If so, all these candidates are eliminated and removed from the list. The process continues with the next best correlated candidate in the list (among all those which have not yet been eliminated from it). A practical radius of the circular area is 30% the length of the tab's shorter edge. Finally, one gets a short list of candidates for each indicia element.

Alternative methods for the cluster elimination process can also be utilized.

Stage 5—Edge correlation, 65 in FIG. 11a. Due to several reasons (such as those mentioned in Stage 3), one may obtain “false alarms” about reasonably correlated positions which do not correspond to an actual indicia element. To eliminate such errors, edge correlation is adopted to determine the true indicia locations.

First, the edge map of the indicia pattern is generated, as shown in FIG. 12, using some edge-detection algorithm such as the Sobel or Canny methods. For edge-detection see Gonzalez, et al (2004) Digital Image Processing (Pearson Prentice Hall, NJ) pp. 384-393. To tolerate some inclination of the tab, a low-pass filter (Gaussian filter or any other) is applied to the indicia edge map, resulting in a blur of the edge map as shown in FIG. 13. The blurred edge-map is thresholded, such that its pixels are mapped to binary black and white values; for instance, those above 0.2 are mapped to 1, and the remaining ones are mapped to 0.

Next, for each candidate position remaining after Stage 4, one extracts from the normalized image the segment area which is the same size as an indicia element, and which possibly contains the image of the indicia element in the input image. The edge maps of all segments are calculated, and these are correlated with the blurred and threshholded indicia edge map, The segment showing the best correlation is selected as the true indicia element location, provided that this correlation value exceeds some minimum value X (X can be selected as some percentile of the number of white pixels in the blurred, thresholded edge-map of the indicia.). This minimum value ensures that if no indicia element exists in the input image then the method does not return any result. Also, by altering the value of X one can control the amount of inclination of the tab that the method will accept—higher values of X correspond to less tolerance to inclination, i.e. it will accept only smaller inclinations.

Stage 6—Cropping, 65 in FIG. 11a. Once the locations of the indicia are resolved in the normalized image, the source image can be cropped accordingly. Since the horizontal and vertical directions of a digitized image are known, the locations of the two indicia uniquely define the cropping rectangle.

If the source image had a resolution higher than 100 dpi, then it was down-sampled at the preprocessing Stage 1. In this case, each one of the 4 positions in the low-resolution normalized image designating a corner of the cropping region, maps to a square region of several positions in the high-resolution image. To resolve the ambiguity, the central position of each such region is selected, producing 4 cropping points in the original high-resolution input image. The choice of the central point minimizes the error introduced in the cropping region due to the translation from low- to high-resolution. Finally, the image of FIG. 2a is cropped according to the 4 cropping corners, as stated in block 67 in FIG. 11a.

Typically an indicia element that is inclined up to 20 degrees can be detected in the correlation operation of Stage 2, whereas an inclination up to 10 degrees can be detected in the edge correlation operation of Stage 5. Thus, referring to FIG. 3, where the inclination of tabs 13 and 14 correspond to the inclination of the document 11, the tabs can be detected provided the inclination angle 15 of the document does not exceed 10 degrees. The programming instructions for rotating an image anti-clockwise to remove an inclination such as in FIG. 3, is well known to those skilled in the art of image processing. See for example the commercial program Adobe®Photoshop®cs2.

Another algorithm that can be used for finding indicia, such as shown in FIG. 1, is the Hough Algorithm (or Hough Transform). The Hough transform can be regarded as a generalized template matching method for pattern recognition based on majority-voting, as is known to those skilled in the art. The Hough transform is typically used to extract edges, curves and other fixed shapes from an image. In the present invention, one may use successive applications of the transform to detect the various components of the indicia pattern independently.

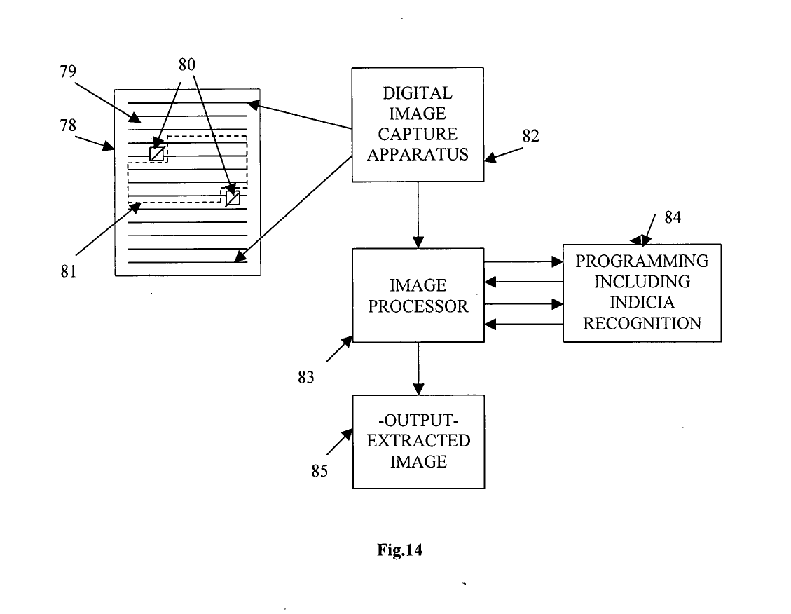

FIG. 14 shows the components of a generalized system for implementing the invention. In FIG. 14 indicia 80, are placed on image 79 on document 78, in order to output the desired image 81. The image 79 plus indicia, 80, are captured by the digital image capturing apparatus 82, which is either a scanner, or a copier or a camera.

By a “scanner” is included a flatbed scanner, handheld scanner, sheet fed scanner, or drum scanner. The first three allow the document to remain flat but differ mainly in whether the scan head moves or the document moves and whether the movement is by hand or mechanically. With drum scanners the document is mounted on a glass cylinder and the sensor is at the center of the cylinder. A digital copier differs from a scanner in that the output of the scanner is a file containing an image which can be displayed on a monitor and further modified with a computer connected to it, whereas the output of a copier is a document which is a copy of the original, with possible modifications in aspects such as color, resolution and magnification, resulting from pushbuttons actuated before copying starts.

The capturing apparatus 82 in FIG. 14 in the case of a scanner or copier usually includes a glass plate, cover, lamp, lens, filters, mirrors, stepper motor, stabilizer bar and belt, and capturing electronics which usually includes a CCD (Charge Coupled Device) array.

The image processor 83 in FIG. 14 includes the software that assembles the three filtered images into a single full-color image in the case of a three pass scanning system. Alternatively the three parts of the CCD array are combined into a single full-color image in the case of a single pass system. An alternative to the Capturing Electronics 82 being based on CCD technology, CIS.(Contact Image Sensor) technology can be used. In some scanners the Image Processor 83 can software enhance the perceived resolution through interpolation. Also the Image Processor 83 may perform processing to select the best possible choice bit depth output when bit depths of 30 to 36 bits are available.

The indicia detection and recognition software 84 in FIG. 14 includes instructions for the algorithm, described with reference to block 70 in FIG. 11a, to recognize uniquely designed indicia. It also includes the instructions for the various functionalities as described with reference to FIGS. 2 to 10 in order to output the desired image 81.

The Output 85 in FIG. 14 in the case of a scanner is a file defining desired image 81, and is typically available at a Parallel Port; or a SCSI (Small Computer System Interface) connector; or a USB (Universal Serial Bus) port or a Firewire. The Output 85 in the case of a copier is a copy of the original document as mentioned above.

In the case of a digital camera the capturing apparatus 82 in FIG. 14 includes lenses, filters, aperture control and shutter speed control mechanisms, beam splitters, and zooming and focusing mechanisms and a two dimensional array of CCD or of CMOS (Complementary Metal Oxide Semiconductor) image sensors.

The image processor 83 for cameras interpolates the data from the different pixels to create natural color. It assembles the file format such as TIFF (uncompressed) or JPEG (compressed). The image processor 83 may be viewed as part of a computer program that also enables automatic focusing, digital zoom and the use of light readings to control the aperture and to set the shutter speed.

The indicia detection and recognition software 84 for cameras is the same as that described for scanners and copiers above, with the additional requirement that the apparent change in size of the indicia pattern due to the distance of the camera from the document, the zooming factor and the tilt, if any, of the optical axis, should be taken into account as explained with reference to FIG. 10.

The Output 85 in FIG. 14 in the case of a digital camera is a file defining desired image 81 and is made available via the same ports as mentioned with respect to scanners, however in some models removable storage devices such as Memory Sticks may also be used to store this output file.

### REFERENCES CITED

### U.S. Patent Documents

U.S. Pat. No. 6,463,220, October, 2002, Dance et al 396/431

### Commercial Software and Products

Adobe®Photoshop®cs2
Microsoft® Paint
QuickLink Pen by ©WizCom Technologies Ltd.

### Other References

Gonzalez, R. C, Woods, R. E and Eddins, S. E (2004) Digital Image Processing (Pearson Prentice Hall, NJ) pp. 205-206 and pp. 384-393
Hartley, Richard and Zisserman, Andrew (2003) Multiple View Geometry in Computer Vision (Cambridge University Press) pp. 178-193.
Kwakernaak, H. and Sivan, R. (1991) Modern Signals and Systems (Prentice Hall Int.), p. 62.
Pratt, W. K (2001) Digital Image Processing, 3rd ed. (John Wiley & Sons, NY) p. 245

What is claimed is:

1. The method for deriving an image from an image bearing document comprising the steps of:
placing relatively small machine identifiable indicia with the document in at least one location;
recording the document image;
identifying the indicia, and
deriving the desired image using the identified indicia.

2. The method of claim 1, where the positioning of the indicia designates an image to be cropped.

3. The method of claim 1, where the recording of the document image is accomplished through scanning the document image including the indicia.

4. The method of claim 1, where the recording of the document image is accomplished through photographing the document image including the indicia.

5. The method of claim 1, where the section of the indicia primarily identified comprises an image which when rotated through 180 degrees results in the inverse of the image.

6. The method of claim 1, where the indicia comprise relatively unmovable bodies.

7. The method of claim 1, where the positioning of the indicia indicate the degree of rotation of the image of the document from the desired orientation.

8. The method of claim 1, where the positioning of the indicia designates the manner of assembly of the derived image with the one to follow.

9. The method of claim 1, where image processing instructions derive from the code on a code enhanced indicia element.

10. The method of claim 9, where the code enhanced indicia element designates the manner of assembly of the derived image with the one to follow.

11. The method of claim 9, where the code enhanced indicia element designates characteristics of the image to be produced.

12. The method of claim 9, where the code enhanced indicia element designates the activation of optical character recognition and word processing for reproduction of text.

13. The method of claim 12, where the code enhanced indicia element designates the translation of text into another language.

14. The method of claim 4, where the relative size of the indicia is obtained through automatic distance measurement from the camera to the document and the zooming factor used.

15. The method of claim 4, where the relative size of the indicia is obtained by including with the desired image a grid pattern of known dimensions relative to the size of each indicium element.

16. The method of deriving a desired assembly of a document image comprising the steps of:
placing identifiable indicia with at least one document at selected positions, which by their data content and location delineate an image extraction, processing and assembly program;
scanning and recording each document, including indicia, to record those portions of the image delineated by the indicia for extraction;
processing and assembling the recorded portions in accordance with the program, and
outputting the resulting image to a document.

17. The method as set forth in claim 16, wherein the images are to be extracted from at least two separate documents.

18. The method as set forth in claim 16, wherein the images are extracted from the same document whose outside dimensions exceed the dimensions of the area swept by the scanning head, and where the steps include:
delineating the boundaries of different adjacent areas on the original document by positioned indicia;
scanning the different areas of the document;
assembling the recorded portions in accordance with the delineated boundaries;
adjusting during processing if necessary the scale of the assembled image to match the means of reproduction, and
reproducing the original document to the final scale.

19. The method as set forth in claim 16, wherein the image of the document comprises alphanumeric text, and wherein the method includes placing indicia with the document including designation of a translation language, and wherein the steps further include supplying the scanning output with optical character recognition, translating the text to the selected translation language, and outputting the text in the selected language.

20. A method for identifying encoding on indicia-bearing elements containing instructions for excerpting portions of a document as it is being scanned, comprising the steps of:
normalizing the original image including an indicia-bearing element thereon;
obtaining correlation values between the indicia image and the normalized image;
identifying the indicia in accordance with the correlation values, and
identifying the instructions associated with the indicia.

21. The method as set forth in claim 20, and including the further steps of:
thresholding the correlation values;
providing clusters of high correlation values for individual indicia elements;
choosing a single representative value from each cluster, and
carrying out an edge correlation to select the best representative value.

22. The method as set forth in claim 21, further including the steps of
storing image information as to the document being scanned, and
using the instructions provided by the best representative values.

23. A system for deriving a selected image from an image-bearing basic document, comprising:
at least one indicia member placed with the document and bearing instructions for production of the image to be derived;
an image reproduction machine for scanning the image, including the at least one indicia member;
a memory apparatus responsive to the scanner for retaining data as to the image on the document; and
a data processor responsive to signals representing the recorded image and the at least one indicia member for deriving the selected image from the document.

24. A system as set forth in claim 23, wherein the system further includes data output means responsive to the data processor for presenting the derived image.

25. A system as set forth in claim 23, wherein the instructions for the derivation of the selected image are based on the positioning of the at least one indicia member.

26. The system of claim 23, where the instructions for the derivation of the selected image are based on encoded instructions on the at least one indicia member.

27. A system as set forth in claim 23, wherein the data processor includes a program control for recognizing instructions contained in the at least one indicia member, for deriving the selected image.

28. A system as set forth in claim 23, wherein the at least one indicia member includes instructions in alpha numeric form and the program control includes an optical character recognition means for reading the alpha numeric instructions.

29. A system as set forth in claim 23, wherein the indicia member is removably retained on the document and in size comprises a small fraction of the image on the document.

30. A system for producing an extracted image of a portion of a document in accordance with instructions contained in indicia selectively placed with the document, comprising:
a scanning system for providing a digital record of the document, including the indicia;
a data processing system receiving the digital record and identifying the instructions, the processing system including programming means for extracting that part of the image defined by the instructions, and
an output device responsive to the data processing system for presenting the extracted image.

31. A system for processing a document to produce a desired document comprising:
designating any part to be extracted from the document with at least one relatively small and uniquely patterned indicia element placed with the document,
placing the document with the indicia in a digital image capturing and reproduction machine,
identifying the indicia using an indicia identifying logarithm,
processing the designated part according to the features of the desired document.

32. The system of claim 31, where the features of the desired document appear in a list on a computer screen from which the desired features may be selected.

33. The system of claim 32, where the list of features includes the cropping of the designated part.

34. The system of claim 32, where the list of features includes the rotation of the designated part.

35. The system of claim 32, where the list of features includes the manner of assembly of the designated part with the one to follow.

36. The system of claim 32, where the list of features includes characteristics of the image to be produced.

37. The system of claim 32, where the list of features includes the activation of word processing.

38. The system of claim 37, where the list of features includes the language into which text should be translated.
